(19) United States
(12) Patent Application Publication
(10) Pub. No.: US 2008/0125927 A1
(43) Pub. Date: May 29, 2008

(54) Operating Method for a Hybrid Drive

(75) Inventors: Markus Gohring, Nufringen (DE); Marco Fleckner, Leonberg (DE); Nils Sauvlet, Bad Essen (DE); Dieter Kraxner, Wurmberg (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 11/829,997

(22) Filed: Jul. 30, 2007

(30) Foreign Application Priority Data
Jul. 28, 2006 (DE) DE102006034934.2

(51) Int. Cl. B60W 20/00

(52) U.S. Cl. 701/22; 903/902

(57) ABSTRACT

The invention relates to a method for operating a drive train (1) comprising an internal combustion engine (2), an electric motor (10) and an automatic transmission (11), in which, during an operating state with the electric motor (10) switched on and the internal combustion engine (2) switched off, the internal combustion engine (2) is engaged by a transmission of torque to the internal combustion engine (2), used to accelerate the internal combustion engine (2), being coupled in time with a downshift operation in the automatic transmission (11).

The present invention relates to a method for operating a drive train comprising an internal combustion engine, an electric motor and an automatic transmission.

A drive which is equipped with such a drive train is also designated a hybrid drive and is used in particular in modern motor vehicles, in particular automobiles. If the associated drive train is configured in such a way that the internal combustion engine and electric motor are able to introduce torque into the drive train not only alternatively but also cumulatively, mention is also made of a parallel hybrid drive.

Hybrid drives of this type are distinguished by reduced fuel consumption and by reduced pollutant emissions. In order to reduce weight, it is expedient in this case to equip the drive train of the hybrid drive only with an electric motor which, firstly, is needed for the introduction of the torque into the drive train during the electric operating state and with which, secondly, the internal combustion engine can be driven for the purpose of starting it, in order to change to an internal combustion operating state or into a dual operating state. If there is only one electric motor, there is the difficulty during the electric operating state that the engagement of the internal combustion engine can be associated with torque fluctuations in the drive train, which can lead to a jolt that is noticeable by the vehicle driver, which is felt as a cost in terms of comfort. At the same time, there is a demand for the internal combustion engine to be capable of engagement comparatively quickly, in order for example to be able to meet an increased desire for power by the vehicle driver as far as possible without delay. In order to be able to achieve the desired spontaneity for the starting of the internal combustion engine, however, relatively high torques have to be taken from the drive train, which intensifies the undesired torque fluctuations further.

The present invention deals with the problem of specifying an operating method for a drive train of the type mentioned at the beginning which, in particular, is distinguished by increased comfort when the internal combustion engine is engaged.

According to the invention, this problem is achieved by the subject of the independent claim. Advantageous embodiments are the subject of the dependent claims.

The invention is based on the general idea of coupling the engagement of the internal combustion engine with a downshift operation of the automatic transmission. In the sense of the present invention, the term “automatic transmission” comprises any type of automated transmissions, in particular dual clutch transmissions. A downshift operation triggered by a desire of the vehicle driver to accelerate leads to a relatively high increase in torque at the transmission output in any case which, at least in the event of a strong desire to accelerate, leads to a more or less intense, desired jolt in the drive train. As a result of coupling the engagement operation with the downshift operation, an additional jolt resulting from the engagement of the internal combustion engine can be avoided. In the ideal case, the engagement of the internal combustion engine thus remains unnoticed, so to speak, by the vehicle driver. In this case, the invention makes use of the finding that, in the event of a relatively high power demand at the transmission output during the electric operating state, both engagement of the internal combustion engine and a downshift of the automatic transmission can be carried out, in order to meet the desire of the vehicle driver for power. At least in the event of a torque demand at the transmission output which exceeds a predetermined limiting value, the engagement of the internal combustion engine is coupled with the downshift operation in the automatic transmission.

Preferably, the downshift operation coupled with the engagement of the internal combustion engine can be carried out differently with regard to at least one parameter than a standard downshift operation, which is not coupled with the engagement of the internal combustion engine. For instance, there is such a standard downshift operation when the drive train is being operated in the internal combustion operating state or in the dual operating state or when the desire of the vehicle driver to accelerate is so small that engagement of the internal combustion engine is not necessary. Parameters which can be varied during the downshift operation coupled with the engagement of the internal combustion engine as compared with a standard downshift operation are, for example, a downshift time and/or a reduction in torque at the transmission input.

In another advantageous embodiment, provision can be made for the internal combustion engine to reach a starting state as soon as the respective piston in one of its cylinders has completed a complete compression stroke for the compression of fresh gas, the internal combustion engine then being started by means of specific injection of fuel into the aforementioned cylinder and by igniting the fuel-fresh gas mixture in this cylinder. The following expansion stroke in this one cylinder already contributes considerably to the acceleration of the internal combustion engine. In this way, firstly, the energy to be applied from the rest of the drive train in order to accelerate the internal combustion engine can be reduced considerably, while, secondly, the time required for the starting operation is reduced. Such a rapid-starting method for the internal combustion engine is made possible by modern fuel injection systems and engine control systems which are informed about the current position of the piston in the respective cylinder, for example via the registration of the crankshaft angle.

Further important features and advantages of the invention emerge from the subclaims, from the drawings and from the associated figure description using the drawings.

It goes without saying that the features mentioned above and those still to be explained below can be used not only in the respectively specified combination but also in other combinations or on their own without departing from the scope of the present invention.

A preferred exemplary embodiment of the invention is illustrated in the drawing and will be explained in more detail in the following description.

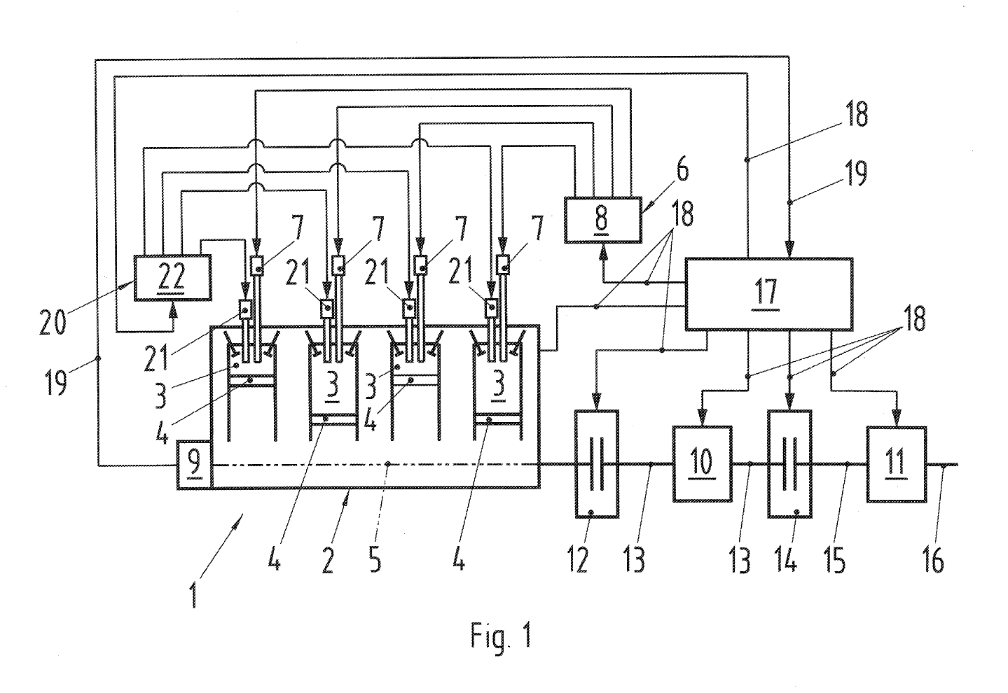

The single FIG. 1 shows a highly simplified basic illustration of a drive train in the manner of a circuit diagram.

According to FIG. 1, a drive train 1 comprises an internal combustion engine 2 having a plurality of cylinders 3, in which in the usual way pistons 4 are mounted such that they can be displaced in a reciprocating manner. The pistons 4 are coupled in drive terms, in a conventional manner that is not shown, via connecting rods to a crankshaft 5, which is indicated here by a dash-dotted line. The internal combustion engine 2 is equipped with a fuel injection system 6 which has an injection nozzle 7 for each cylinder 3 and comprises an injection control system 8, with which the injection nozzles 7 can be actuated. The cylinders 3 are additionally equipped in the conventional way with gas exchange valves, not specifically designated. A fresh gas supply, a waste gas discharge and a fuel supply are present in the usual way but not shown here for the purpose of simplified illustration. In addition, the internal combustion engine 2 is further provided with a crankshaft sensor 9, with which the current crankshaft angle can be registered, via which the current position of each piston 4 in the associated cylinder 3 can be determined.

Furthermore, the internal combustion engine 2 is equipped with an ignition system 20 which has an ignition device 21, in particular a spark plug, for each cylinder 3. The individual ignition devices 21 can be actuated via an ignition control system 22.

The drive train 1 additionally comprises an electric motor 10 and an automatic transmission 11, in particular an automatic gearbox 11. The electric motor 10 can be coupled to the internal combustion engine 2 via a first clutch 12. To this end, the first clutch 12 is connected on one side to the crankshaft 5 of the internal combustion engine 2 and on the other side to a drive shaft 13 of the electric motor 10. The first clutch 12 can be configured, for example, as an isolating clutch. Furthermore, the electric motor 10 can be connected to the automatic transmission 11 via a second clutch 14. To this end, the second clutch 14 is connected on one side to the drive shaft 13 of the electric motor 10 and on the other side to a transmission input 15 of the automatic transmission 11. The second clutch 14 can be configured, for example, as a torque converter with integrated lock-up clutch or as a pure clutch. Pure friction clutches can be considered both for the first clutch 12 and for the second clutch 14. The second clutch 14 can in particular be integrated into the automatic transmission 11. A transmission output 16 from the automatic transmission 11 permits the drive output provided by the drive train 1 to be picked off.

The drive train 1 is preferably arranged in a motor vehicle, in particular in an automobile. The transmission output 16 then drives drive wheels of the vehicle. The drive train 1 has different drive principles with the internal combustion engine 2 and the electric motor 10 and is therefore designated a hybrid drive. If the two different drive concepts can be active at the same time, this is a parallel hybrid drive.

In order to drive the individual components of the drive train 1, a control system 17 is provided, which is able to drive the injection control system 8, the ignition control system 22, the internal combustion engine 2, the clutches 12, 14, the electric motor 10 and the automatic transmission 11 via appropriate control lines 18. Via a signal line 19, the control system 17 receives, for example, a sensor signal from the crankshaft sensor 9.

According to the invention, the drive train 1 according to FIG. 1 can be operated as follows:

With the aid of the drive train 1, the intention is for a desired torque to be provided at the transmission output 16. This desired torque can depend on different boundary conditions. If the drive train 1 is arranged in a vehicle, the desired torque primarily depends on the wish of the vehicle driver. Depending on the wish of the vehicle driver, the desired torque can be constant over a relatively long time period or vary. In an electric operating state, the desired torque is generated exclusively with the aid of the electric motor 10. The electric operating state is suitable for example for city journeys of the vehicle equipped with the drive train 1. In an internal combustion operating state, the respective desired torque is generated exclusively with the aid of the internal combustion engine 2. The internal combustion operating state is suitable for example for overland journeys or freeway journeys. At the same time, in the internal combustion operating state, a vehicle battery which provides the power for operating the electric motor 10 can be charged up if, in the internal combustion operating state, the internal combustion engine 2 supplies excess energy. In particular, in this case the electric motor 10 can be operated as a generator. In a dual operating state, the respective desired torque is generated in combined form by the internal combustion engine 2 and the electric motor 10. This dual operating state can be used, for example, to optimize the vehicle acceleration.

During the electric operating state, that is to say during an operating state with the electric motor 10 switched on and the internal combustion engine 2 switched off, it may be necessary to switch on and engage the internal combustion engine 2 under predetermined preconditions. For example, in order to change from the electric operating state to the internal combustion operating state or to the dual operating state. The engagement of the internal combustion engine 2 during the electric operating state becomes necessary in particular when the vehicle driver demands a considerably increased desired torque, that is to say signals a relatively strong desire to accelerate via the gas pedal of the vehicle. This change of the operating state is to be implemented as far as possible without costs in terms of comfort to the vehicle driver. Furthermore, a rapid response behavior, that is to say rapid engagement of the internal combustion engine 2, is also desired.

In order to be able to satisfy the aforementioned stipulations of increased comfort and short response time, during the electric operating state a transmission of torque to the internal combustion engine 2, which is used to start the internal combustion engine 2 turning or to accelerate it, is coupled in time to a downshift operation proceeding in the automatic transmission 11. This time coupling is carried out specifically in such a way that a jolt in the drive train 1 triggered by the engagement of the internal combustion engine 2 coincides with a jolt triggered by the downshift operation or is buried in the latter. In this way, during the engagement of the internal combustion engine 2, only a single, more or less intense jolt occurs in the drive train 1, which for the vehicle driver occurs in a manner which is accustomed and therefore expected, namely when shifting down in order to introduce a relatively powerful acceleration operation. To this extent, the vehicle driver does not further notice the engagement of the internal combustion engine. In this case, a downshift operation is understood as a shift operation in which a shift is made from a higher gear with a longer ratio to a lower gear with a shorter ratio, for example from fourth gear to third gear.

In a preferred embodiment, the engagement of the internal combustion engine 2 is coupled with a downshift operation in the automatic transmission 11 only when a desired torque which exceeds a predetermined limiting value has to be output or provided at the transmission output 16. Additionally or alternatively, a change in the desired torque can be used as a shifting criterion if this change exceeds a predetermined limiting value. Likewise, under specific preconditions, it may be necessary to engage the internal combustion engine 2 without there being any change in the desired torque. For example, a change is made to the internal combustion operating state or to the dual operating state when batteries for the power supply of the electric motor 10 are exhausted. Furthermore, it is clear that not every downshift operation of the automatic transmission 11 must be coupled with an engagement of the internal combustion engine 2.

According to an advantageous embodiment, the downshift operation coupled with the engagement of the internal combustion engine 2 can be distinguished from a standard downshift operation not coupled with the engagement of the internal combustion engine 2, specifically with regard to at least one parameter. Parameters which influence the shift operations in the automatic transmission 11 are normally stored in a transmission control system, not shown here, preferably in characteristic maps.

A parameter that is important for each downshift operation is, for example, the downshift time. Each downshift operation begins with a time delay with respect to the gas pedal actuation by the vehicle driver. In a preferred embodiment, the downshift operation coupled with the engagement of the internal combustion engine 2 can be carried out only at a downshift time which is advanced as compared with a standard downshift time of the associated standard downshift operation. By means of this measure, the torque output at the transmission output, increased considerably by the engagement of the internal combustion engine 2, can be synchronized with the torque increase at the transmission output caused by the downshift operation. In this way, with the downshift operation, all of the potential acceleration is available immediately, which improves the dynamic driving characteristics of the vehicle.

Another important parameter for the control of a downshift operation in the automatic transmission 11 is a reduction in torque at the transmission input, which is normally carried out at the start of the downshift operation, in order to keep an instantaneous moment step during the shift operation as small as possible. In this way, the loading of the components of the drive train 1 can be reduced; at the same time, an increase in comfort results. During a standard downshift operation, such a torque reduction can be achieved, for example, by the torque introduced into the drive train 1 by the electric motor 10 and/or by the internal combustion engine 2 being reduced appropriately.

In an advantageous embodiment of the operating method, when engaging the internal combustion engine 2, at least some of the requisite torque reduction at the transmission input 15 can then be implemented by means of the torque transmission to the internal combustion engine 2, which is used to accelerate the internal combustion engine 2 as the latter is engaged. In this embodiment, use is made of the finding that the energy which has to be taken from the drive train 1 for the necessary torque reduction can be used to accelerate the internal combustion engine 2 during the engagement of the latter.

Additionally or optionally, provision can also be made for the torque reduction required for the downshift operation when engaging the internal combustion engine 2 to be implemented at least partly by the electric motor 10 being operated temporarily as a generator. By means of the generator operation, torque can be taken from the drive train 1 and in particular can be used for charging the batteries. This embodiment is also based on the thought of using the excess energy contained in the drive train 1 expediently.

Preferably, during the engagement of the internal combustion engine 2, the whole of the torque reduction required for the downshift operation is implemented by the transmission of torque to the internal combustion engine 2 needed to accelerate the internal combustion engine 2 and—if the torque reduction exceeds the transmission of torque to the internal combustion engine 2—by the operation of the electric motor 10 as a generator.

As soon as the internal combustion engine 2 has been accelerated or cranked sufficiently, it can be started when it reaches its starting state, by the injection system 6 and the ignition system 20 being driven appropriately.

As soon as the predetermined starting state of the internal combustion engine 2 has been reached during its acceleration, the actual starting operation of the internal combustion engine 2 is carried out. This starting state is reached, for example, when the internal combustion engine 2 reaches a predetermined starting speed. The starting of the internal combustion engine 2 then corresponds to a conventional starting operation, in which the injection system 6 and the ignition system 20 are synchronized during a few revolutions of the crankshaft 5.

In another embodiment, provision can be made to carry out a rapid starting operation for the internal combustion engine 2, at least as it is engaged. During such a rapid starting operation, the internal combustion engine 2 reaches its starting state as soon as the associated piston 4 in the first of its cylinders 3 has completed a complete compression stroke, during which it compresses fresh gas that is taken in. It is therefore necessary for a complete filling with fresh gas and compression of the filling to have taken place in one of the cylinders 3. Via the crankshaft sensor 9, the control system 17 knows the current crankshaft angle and, as a result, the current position of each piston 4 in the respective cylinder 3. The control system 17 thus knows exactly when in which cylinder 3 the associated piston 4 has first completed the complete compression stroke. Via the injection system 8, this cylinder 3 is then specifically supplied with fuel, by the suitable quantity of fuel being injected via the injection nozzle 7. Via the ignition system 20, in precisely this cylinder 3, the fuel-fresh gas mixture formed therein is ignited by the appropriate ignition device 21. The following expansion stroke of the respective piston 4 drives the crankshaft 5 and leads to additional acceleration of the internal combustion engine 2. A short time later, the next ignition operation can already be carried out. During this rapid starting method, the crankshaft 5, the injection system 6 and the ignition system 20 are synchronized from the start, so to speak, which means that the internal combustion engine 2 can be started extremely rapidly. Such a rapid starting method can be implemented in particular in the case of a spark ignition engine with direct injection.

As a result of the rapid starting of the internal combustion engine 2, the kinetic energy to be provided by the rest of the drive train 1 in order to crank the crankshaft 5 or to start it turning is relatively small. This also has a positive effect on the comfort and the spontaneity of the engagement operation.

Following the starting of the internal combustion engine 2, the control system 17 carries out synchronization of the electric motor 10 and of the internal combustion engine 2, in order to equate their speeds to each other. Only then can the first clutch 12 be engaged completely, in order to transmit torque without slippage between crankshaft 5 and drive shaft 13.

A dual operating state is then initially present, in which electric motor 10 and internal combustion engine 2 introduce so much torque in total into the drive train 1 that the respective desired torque is provided at the transmission output 16. If required, after the dual operating state or immediately after the synchronization of electric motor 10 and internal combustion engine 2, a change can be made to the internal combustion operating state. To this end, the control system 17 operates the internal combustion engine 2 in such a way that the latter introduces so much torque into the drive train 1 that the desired torque can be picked off at the transmission output 16. At the same time, the electric motor 10 is switched off. If the internal combustion engine 2 has reserves of power and if batteries for operating the electric motor 10 have to be charged up, the internal combustion engine 2 can also transmit an appropriate excess of power into the drive train 1, which can then be taken from the drive train 1 again via an appropriate generator, in particular via the electric motor 10 operated as a generator.

1-10. (canceled)

11. A method of operating a drive train including an internal combustion engine, an electric motor, and an automatic transmission, the method which comprises:
starting out from a first operating state, in which the electric motor is switched on and the internal combustion engine is switched off, adding the internal combustion engine by transmitting a torque to the internal combustion engine, to thereby accelerate the internal combustion engine, and temporally coupling the transmitting of the torque with a downshift operation of the automatic transmission.

12. The method according to claim 11, wherein the downshift operation coupled with an engagement of the internal combustion engine differs with regard to at least one parameter from a standard downshift operation that is not coupled with the engagement of the internal combustion engine.

13. The method according to claim 11, which comprises carrying out the downshift operation coupled with the engagement of the internal combustion engine at a downshift time which is advanced with respect to a standard downshift time during a standard downshift operation that is not coupled with the engagement of the internal combustion engine.

14. The method according to claim 11, which comprises, during the downshift operation coupled with the engagement of the internal combustion engine, implementing a torque reduction at a transmission input, which is carried out during a standard downshift operation that is not coupled with the engagement of the internal combustion engine, at least partly by way of the torque transmission to the internal combustion engine used to accelerate the internal combustion engine.

15. The method according to claim 11, which comprises, during the downshift operation coupled with the engagement of the internal combustion engine, implementing a torque reduction at a transmission input, which is carried out during a standard downshift operation not coupled with the engagement of the internal combustion engine, at least partly by operating the electric motor as a generator.

16. The method according to claim 11, which comprises starting the internal combustion engine upon reaching a starting state thereof.

17. The method according to claim 16, which comprises:
determining the starting state of the internal combustion engine by a predetermined starting speed; or
determining that the internal combustion engine has reached the starting state when a respective piston in one cylinder of the engine has completed a complete compression stroke for the compression of fresh gas, and starting the internal combustion engine by way of specific injection of fuel into the one cylinder and by igniting the fuel-fresh gas mixture in the one cylinder.

18. The method according to claim 16, which comprises, following the starting of the internal combustion engine, synchronizing a rotational speed of the electric motor and a rotational speed of the internal combustion engine.

19. The method according to claim 18, which comprises, after the electric motor and the internal combustion engine are synchronized, adjusting a torque introduced in total into the drive train by the electric motor and the internal combustion engine to thereby introduce a current desired torque into the transmission input.

20. The method according to claim 18, which comprises, after the electric motor and the internal combustion engine are synchronized, switching the electric motor off and adjusting a torque introduced into the drive train by the internal combustion engine to thereby introduce a current desired torque into the transmission input.
